(19) United States
(12) Patent Application Publication
(10) Pub. No.: US 2026/0339299 A1
(43) Pub. Date: Oct. 29, 2026

(54) SYSTEMS AND METHODS FOR EMERGENCY SUPERVISION OF FIRE-FIGHTING WATER PRESSURE IN SMART CITIES BASED ON INTERNET OF THINGS (IOT) LARGE MODELS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Rui RU, Chengdu (CN)

(73) Assignee: CHENGDU QINCHUAN IOT TECHNOLOGY CO., LTD., Chengdu (CN)

(21) Appl. No.: 19/707,519

(22) Filed: Jun. 15, 2026

(30) Foreign Application Priority Data
Apr. 27, 2026 (CN) 202610560863.7

(51) Int. Cl. G05B 19/416

(52) U.S. Cl. CPC G05B 19/416; G05B 2219/37371

(57) ABSTRACT

A system and a method for emergency supervision of fire-fighting water pressure in a smart city based on an IoT large model are provided. The system includes an emergency supervision management platform configured to: determine a water supply abnormality location based on sensing data at preset locations in a fire-fighting pipeline network; determine a water supply abnormality type at the water supply abnormality location based on sensing data at the water supply abnormality location; determine a pressurization parameter and/or a maintenance parameter based on the water supply abnormality location and the water supply abnormality type; generate, based on the pressurization parameter, a pressurization instruction including pressurization key nodes and preset water pressures; and generate, based on the maintenance parameter, a maintenance instruction including a maintenance location and a maintenance operation.

### CROSS-REFERENCE TO RELATED APPLICATIONS

This application claims priority to Chinese Patent Application No. 202610560863.7, filed on Apr. 27, 2026, the entire contents of which are hereby incorporated by reference.

### TECHNICAL FIELD

The present disclosure relates to the field of fire-fighting water pressure supervision, and in particular to a system and a method for emergency supervision of fire-fighting water pressure in a smart city based on an Internet of Things (IoT) large model.

### BACKGROUND

With the development of smart city construction, real-time monitoring and emergency response of fire-fighting water pressure have become increasingly important for public safety assurance. At present, some urban fire-fighting water pressure supervision systems have basic data acquisition and remote monitoring capabilities, and are able to reflect an operating state of a fire-fighting pipeline network to a certain extent. However, in the face of complex and dynamic urban environments, such as different building functions, seasonal variations, crowd flow fluctuations, and special events, existing systems are insufficiently precise in perceiving and determining the operating state, and lack deep integration and dynamic adaptation capabilities with respect to multi-source environmental factors, resulting in delayed abnormality identification and emergency response.

Therefore, it is desirable to provide a system and a method for emergency supervision of fire-fighting water pressure in a smart city based on an IoT large model, which can improve accuracy, timeliness, and intelligence of urban fire-fighting water pressure management.

### SUMMARY

One or more embodiments of the present disclosure provide a system for emergency supervision of fire-fighting water pressure in a smart city based on an Internet of Things (IoT) large model, the system comprising: an emergency supervision management platform. The emergency supervision management platform is configured to: determine a water supply abnormality location based on sensing data at preset locations in a fire-fighting pipeline network; determine a water supply abnormality type at the water supply abnormality location based on sensing data at the water supply abnormality location; determine a pressurization parameter and/or a maintenance parameter based on the water supply abnormality location and the water supply abnormality type; generate, based on the pressurization parameter, a pressurization instruction including pressurization key nodes and preset water pressures, the pressurization instruction being configured to control corresponding fire-fighting water pumps at the pressurization key nodes to adjust water pressures at the pressurization key nodes to the preset water pressures; and generate, based on the maintenance parameter, a maintenance instruction including a maintenance location and a maintenance operation, the maintenance instruction being configured to control a maintenance robot to move to the maintenance location and perform the maintenance operation on an abnormal fire-fighting water pump.

One or more embodiments of the present disclosure provide a method for emergency supervision of fire-fighting water pressure in a smart city, implemented by an emergency supervision management platform of a system for emergency supervision of fire-fighting water pressure in the smart city based on an IoT large model, the method comprising: determining a water supply abnormality location based on sensing data at preset locations in a fire-fighting pipeline network; determining a water supply abnormality type at the water supply abnormality location based on sensing data at the water supply abnormality location; determining a pressurization parameter and/or a maintenance parameter based on the water supply abnormality location and the water supply abnormality type; generating, based on the pressurization parameter, a pressurization instruction including pressurization key nodes and preset water pressures, the pressurization instruction being configured to control corresponding fire-fighting water pumps at the pressurization key nodes to adjust water pressures at the pressurization key nodes to the preset water pressures; and generating, based on the maintenance parameter, a maintenance instruction including a maintenance location and a maintenance operation, the maintenance instruction being configured to control a maintenance robot to move to the maintenance location and perform the maintenance operation on an abnormal fire-fighting water pump.

One or more embodiments of the present disclosure provide a non-transitory computer-readable storage medium. The storage medium stores computer instructions, and when the computer instructions stored in the storage medium are read by a computer, the computer performs the method for emergency supervision of fire-fighting water pressure in a smart city based on an Internet-of-Things (IoT) large model according to any one of the foregoing embodiments.

### BRIEF DESCRIPTION OF THE DRAWINGS

The present disclosure will be further elucidated by way of exemplary embodiments, which are described in detail with reference to the accompanying drawings. These embodiments are not limiting. In these embodiments, the same reference numerals denote the same structures, wherein:

FIG. 1 is a schematic diagram of a platform architecture of a system for emergency supervision of fire-fighting water pressure in a smart city based on an IoT large model according to some embodiments of the present disclosure.

FIG. 2 is a flowchart of an exemplary process for emergency supervision of fire-fighting water pressure in a smart city according to some embodiments of the present disclosure.

FIG. 3 is an exemplary schematic diagram of determining abnormal intervals corresponding to key nodes according to some embodiments of the present disclosure.

FIG. 4 is a flowchart of an exemplary process for re-determining abnormal key nodes according to some embodiments of the present disclosure.

FIG. 5 is a flowchart of an exemplary process for determining a pressurization parameter according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose. The term “and/or”, as used herein, is merely a way of describing the associative relationship of an associated object, indicating that three relationships may exist, e.g., A and/or B, which may be represented as: A alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

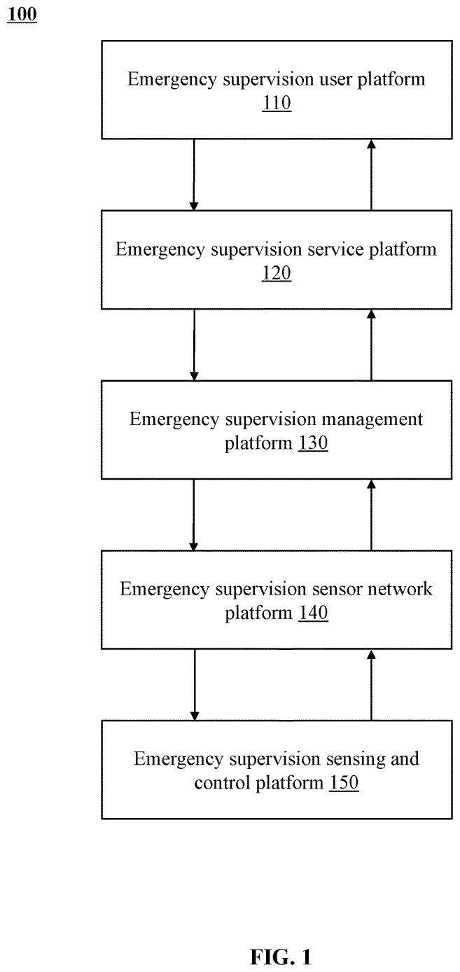

FIG. 1 is a schematic diagram of a platform architecture of a system for emergency supervision of fire-fighting water pressure in a smart city based on an IoT large model according to some embodiments of the present disclosure.

In some embodiments, as shown in FIG. 1, a a system 100 for emergency supervision of fire-fighting water pressure in a smart city based on an IoT large model may include an emergency supervision user platform 110, an emergency supervision service platform 120, an emergency supervision management platform 130, an emergency supervision sensor network platform 140, and an emergency supervision sensing and control platform 150.

The emergency supervision user platform 110 refers to a platform configured to interact with users (e.g., supervisors and citizens), and includes terminal devices, such as mobile devices, tablet computers, consoles, or other devices having input and/or output functions. The emergency supervision user platform 110 may perform bidirectional interaction with the emergency supervision service platform 120.

The emergency supervision service platform 120 refers to an interactive service platform configured to receive and transmit data, and may include servers, gateways, routers, or the like. The emergency supervision service platform 120 may perform bidirectional interaction with the emergency supervision management platform 130.

The emergency supervision management platform 130 refers to an integrated platform configured to process and manage emergency supervision data, and may include processors, servers, storage devices, or the like.

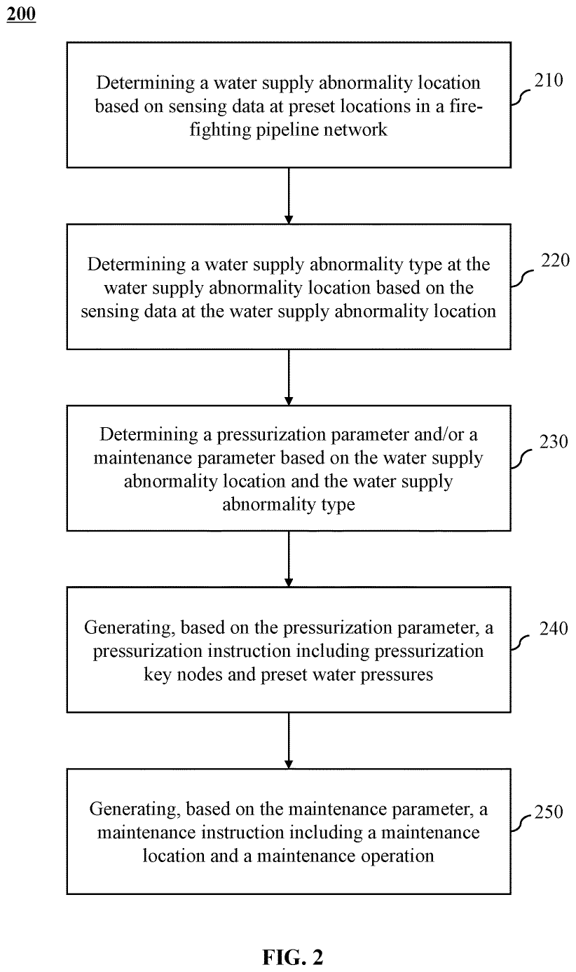

In some embodiments, the emergency supervision management platform 130 may be configured to perform a method for emergency supervision of fire-fighting water pressure in a smart city. More details regarding the method may be found in the related description of FIG. 2.

The emergency supervision sensor network platform 140 refers to a platform configured to comprehensively manage sensing information, and may be configured as a communication network and/or a gateway. The emergency supervision sensor network platform 140 may perform bidirectional interaction with the emergency supervision management platform 130 and the emergency supervision sensing and control platform 150.

The emergency supervision sensing and control platform 150 refers to a platform configured for emergency supervision data acquisition, supervision information generation, and control information execution. In some embodiments, the emergency supervision sensing and control platform 150 may include various devices, such as fire-fighting water pumps, sensors, and maintenance robots. More details regarding the fire-fighting water pumps, the sensors, and the maintenance robots may be found in FIG. 2 and the related description thereof.

More details regarding the above platforms may be found in FIGS. 2-5 and the related descriptions thereof.

In some embodiments, the system 100 may further include a processor configured to process data and/or information related to the system. In some embodiments, the processor may include one or more sub-processing devices. By way of example only, the processor may include a central processing unit (CPU), an application-specific integrated circuit (ASIC), or the like, or any combination thereof.

In some embodiments, the processor may interact with the plurality of platforms included in the system 100, and may also be disposed in one or more of the plurality of platforms.

In some embodiments, the system 100 may form a closed-loop information flow among the plurality of platforms to achieve coordinated and regular operation, and may automatically and intelligently implement emergency monitoring of urban fire-fighting water pressure. By monitoring fire-fighting water pressure in real time and automatically generating emergency measures, the system can effectively improve emergency response speed and reliability of urban fire-fighting water supply. Meanwhile, the use of the IoT large model enables more efficient and comprehensive data fusion, analysis, and decision-making.

FIG. 2 is a flowchart of an exemplary process for emergency supervision of fire-fighting water pressure in a smart city according to some embodiments of the present disclosure. As shown in FIG. 2, a process 200 includes the following steps. In some embodiments, the process 200 may be performed by the emergency supervision management platform of the system 100 for emergency supervision of fire-fighting water pressure in a smart city based on an IoT large model, for example, by a processor.

In 210, a water supply abnormality location is determined based on sensing data at preset locations in a fire-fighting pipeline network.

A preset location refers to a location within the fire-fighting pipeline network that is to be monitored. In some embodiments, the preset locations include key nodes and fire-fighting water pumps.

A key node refers to a critical location in the fire-fighting pipeline network for monitoring water supply safety. For example, the key nodes may include an inlet of a main water supply pipe where municipal water supply is introduced into the fire-fighting pipeline network, a liquid level monitoring location and a pressure monitoring location of a fire-fighting water tank or reservoir, an inlet of a fire-fighting water supply branch pipe for each fire compartment, and hydrant outlets or sprinkler terminals that are farthest from the fire-fighting water pumps, located at the highest positions, or associated with the greatest resistance among multiple fire compartments.

The sensing data refers to monitoring data representing a state of the fire-fighting pipeline network. In some embodiments, the sensing data at the preset locations may include hydraulic data of the key nodes and operating data of the fire-fighting water pumps.

The hydraulic data of the key nodes may include water pressure data and flow rate data of the key nodes.

The operating data of the fire-fighting water pumps may include pump current, pump vibration data, bearing temperature, pump outlet pressure, pump outlet flow rate, pump rotational speed, or the like.

In some embodiments, the sensing data at the preset locations may be obtained via sensors deployed at the preset locations. The sensors may include pressure sensors, flow sensors, temperature sensors, current sensors, vibration sensors, rotational speed sensors, or the like.

The water supply abnormality location refers to a location in the fire-fighting pipeline network at which the sensing data is abnormal. In some embodiments, the water supply abnormality location includes an abnormal key node and an abnormal fire-fighting water pump.

The abnormal key node refers to a key node having abnormal hydraulic data. The abnormal fire-fighting water pump refers to a fire-fighting water pump having abnormal operating data.

In some embodiments, the processor may determine the water supply abnormality location based on the sensing data at the preset locations in the fire-fighting pipeline network in various manners. For example, the sensing data being abnormal may include that the sensing data falls within an abnormal interval. That is to say, when one or more types of sensing data at a preset location fall within corresponding abnormal intervals, the preset location is determined as the water supply abnormality location.

An abnormal interval refers to a value range used to determine whether the sensing data is abnormal. In some embodiments, the abnormal intervals may include a water pressure abnormal interval, a flow rate abnormal interval, a pump current abnormal interval, a pump vibration data abnormal interval, a bearing temperature abnormal interval, a pump outlet pressure abnormal interval, a pump outlet flow rate abnormal interval, a pump rotational speed abnormal interval, or the like.

By way of example, a key node at which water pressure data falls within a water pressure abnormal interval and/or flow rate data falls within a flow rate abnormal interval is determined as an abnormal key node. A fire-fighting water pump that satisfies one or more of the following conditions is determined as an abnormal fire-fighting water pump: a bearing temperature falls within a bearing temperature abnormal interval, a pump current falls within a pump current abnormal interval, pump vibration data falls within a pump vibration data abnormal interval, a pump outlet flow rate falls within a pump outlet flow rate abnormal interval, a pump rotational speed falls within a pump rotational speed abnormal interval, and a pump outlet pressure falls within a pump outlet pressure abnormal interval.

Each preset location has corresponding abnormal intervals, and each type of sensing data has a corresponding abnormal interval. For example, a water pressure abnormal interval of a key node A₁ may be [P₁, P₁′], a flow rate abnormal interval of the key node A₁ may be [F₁, F₁′], a water pressure abnormal interval of a key node A₂ may be [P₂, P₂′], and a bearing temperature abnormal interval of a fire-fighting water pump B₁ may be [T₂, T₂′].

In some embodiments, the abnormal intervals may be preset manually based on experience, and the preset abnormal intervals may be referred to as standard abnormal intervals.

In some embodiments, the processor may determine abnormal intervals corresponding to the preset locations based on scenario features and time-period features of the preset locations.

The scenario features refer to feature information related to an environment in which a preset location is situated. For example, the scenario features may include a building type, a crowd density, or the like. The building type may include a commercial area, a factory, a residential area, or the like.

The time-period features refer to time-related feature information that affects an operating state of a preset location. For example, the time-period features may include a current season, whether the preset location is within a specific event period, a type of the specific event, or the like. Being within a specific event period may be denoted as 1, and not being within a specific event period may be denoted as 0. The type of the specific event may include a sports event, a concert, a holiday, or the like.

In some embodiments, the processor may determine abnormal intervals based on the scenario features and the time-period features of the preset locations in various manners. For example, the processor may determine the abnormal intervals based on the scenario features and the time-period features of the preset locations by querying a scenario configuration repository.

In some embodiments, the scenario configuration repository may be constructed based on a clustering analysis technique. For example, the processor may construct a plurality of clustering vectors, wherein each clustering vector is formed based on historical scenario features and historical time-period features of a historical water supply abnormality location. The historical water supply abnormality locations include historical abnormal key nodes and historical abnormal fire-fighting water pumps at which water supply abnormalities have occurred in the fire-fighting pipeline network. The processor may cluster the plurality of clustering vectors to obtain a plurality of clusters. For each cluster, abnormal data in historical sensing data corresponding to all historical water supply abnormality locations in the cluster may be used to statistically determine historical abnormal ranges of respective types of sensing data in the cluster, and abnormal intervals corresponding to the respective types of sensing data in the cluster may be determined based on the historical abnormal ranges. The determined abnormal intervals are assigned as abnormal intervals corresponding to all clustering vectors in the cluster, thereby constructing the scenario configuration repository.

In the present disclosure, for key nodes, only two types of abnormal conditions, namely insufficient water pressure and/or insufficient flow rate, are considered. Accordingly, for clustering, the historical water supply abnormality locations corresponding to the clustering vectors include historical abnormal key nodes with insufficient water pressure and/or insufficient flow rate and abnormal fire-fighting water pumps having one or more of the above-described abnormal operating data. The specific abnormal data for each historical water supply abnormality location may be pre-labeled.

For example, a cluster may include 500 clustering vectors constructed from historical scenario features and historical time-period features of 500 historical abnormal key nodes. Among these, historical water pressure data of 400 historical abnormal key nodes may be abnormal data, with a minimum value and a maximum value of P and P′, respectively. In this case, a water pressure abnormal interval corresponding to all clustering vectors in the cluster may be [P, P′]. Similarly, historical flow rate data of 450 historical abnormal key nodes may be abnormal data, with a minimum value and a maximum value of F and F′, respectively. Accordingly, a flow rate abnormal interval corresponding to all clustering vectors in the cluster may be [F, F′]. In the same manner, abnormal intervals corresponding to respective types of sensing data may be determined, and all clustering vectors in the cluster correspond to the abnormal intervals determined by the above process.

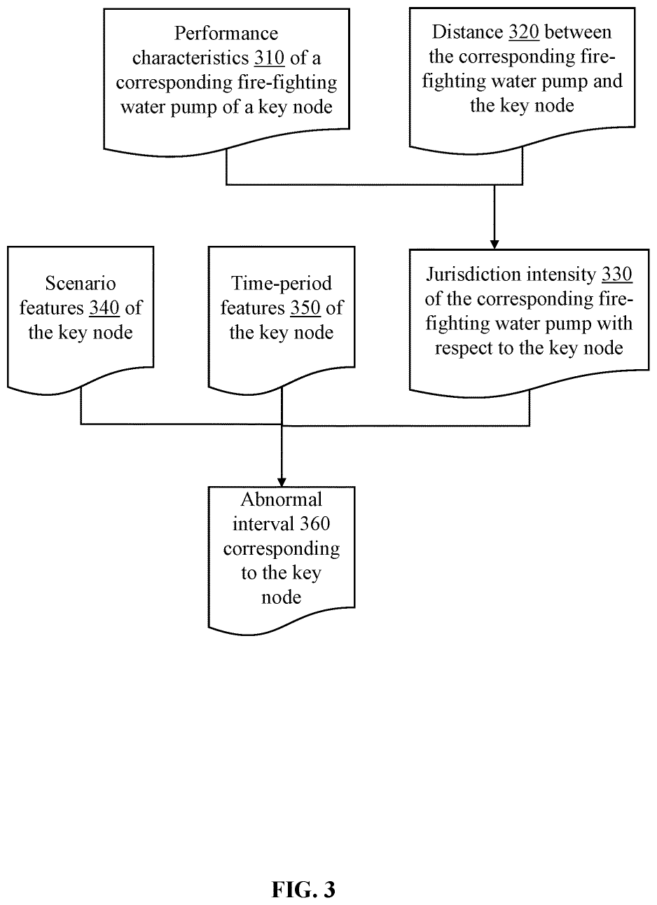

In some embodiments, the processor may determine a jurisdiction intensity of a corresponding fire-fighting water pump with respect to a key node based on performance characteristics of the corresponding fire-fighting water pump of the key node and a distance between the corresponding fire-fighting water pump and the key node; and determine an abnormal interval corresponding to the key node based on scenario features of the key node, time-period features of the key node, and the jurisdiction intensity of the corresponding fire-fighting water pump with respect to the key node. More details may be found in the related description of FIG. 3.

By determining abnormal intervals based on the scenario features and the time-period features of the preset locations, the abnormality determination can better conform to actual operating environments, thereby improving accuracy and adaptability of abnormal interval setting, effectively reducing false positives and missed detections, and enhancing intelligent supervision capability in complex urban environments.

In 220, a water supply abnormality type of the water supply abnormality location is determined based on sensing data at the water supply abnormality location.

The water supply abnormality type refers to a specific category of a water supply abnormality. The water supply abnormality type may include insufficient water pressure, pump start failure, fuse blowing, loose wiring, impeller blockage, insufficient lubrication, or the like.

In some embodiments, the processor may determine the water supply abnormality type of the water supply abnormality location based on sensing data at the water supply abnormality location in various manners.

For example, when the water supply abnormality location is an abnormal key node, the processor may directly determine the water supply abnormality type based on hydraulic data of the abnormal key node. By way of example, when water pressure data of the abnormal key node falls within a water pressure abnormal interval (or is lower than a lower bound of the water pressure abnormal interval), or when the water pressure data falls within the water pressure abnormal interval and flow rate data falls within a flow rate abnormal interval (since flow rate is typically also abnormal when water pressure is abnormal), the water supply abnormality type of the abnormal key node is determined as insufficient water pressure.

As another example, when the water supply abnormality location is an abnormal fire-fighting water pump, the processor may construct a feature vector based on hydraulic data within a water supply coverage of the abnormal fire-fighting water pump and operating data of the abnormal fire-fighting water pump, perform a search in a vector database based on the feature vector to obtain a reference vector having a highest similarity to the feature vector, and determine a label corresponding to the reference vector as the water supply abnormality type corresponding to the abnormal fire-fighting water pump.

The vector database includes a plurality of reference vectors and corresponding labels. Each reference vector is constructed based on historical hydraulic data within a water supply coverage of a historical abnormal fire-fighting water pump and historical operating data of the historical abnormal fire-fighting water pump, and a corresponding label indicates an actual water supply abnormality type of the historical abnormal fire-fighting water pump. The water supply coverage of the fire-fighting water pump may be preset manually. The hydraulic data within the water supply coverage may be an average of hydraulic data of all key nodes within the water supply coverage of the fire-fighting water pump. The similarity may be determined based on a vector distance, and the vector distance may include a Euclidean distance or the like.

In 230, a pressurization parameter and/or a maintenance parameter are determined based on the water supply abnormality location and the water supply abnormality type.

The pressurization parameter refers to one or more parameters related to pressurization operations for resolving water supply abnormalities. For example, the pressurization parameter may include one or more pressurization key nodes, corresponding fire-fighting water pumps of the pressurization key nodes, and preset water pressures.

A pressurization key node refers to a key node in the fire-fighting pipeline network at which pressurization is to be performed. The pressurization key node is an abnormal key node.

A corresponding fire-fighting water pump of a key node refers to a fire-fighting water pump that supplies water to the key node. Each key node has a corresponding fire-fighting water pump. The corresponding fire-fighting water pump of a key node may be preset manually based on a physical structure of the fire-fighting pipeline network and water supply path relationships.

A corresponding fire-fighting water pump of a pressurization key node refers to a fire-fighting water pump that supplies water to the pressurization key node.

A preset water pressure refers to a target water pressure value set to restore normal water supply capability of the fire-fighting pipeline network.

The maintenance parameter refers to one or more parameters related to maintenance operations for resolving water supply abnormalities. For example, the maintenance parameter may include a maintenance location and a maintenance operation.

The maintenance location refers to a location of an abnormal fire-fighting water pump to be repaired.

The maintenance operation refers to a repair action corresponding to a fault of the abnormal fire-fighting water pump. For example, faults of the abnormal fire-fighting water pump may include fuse blowing, loose motor wiring, insufficient lubrication, impeller blockage, or the like. Correspondingly, the maintenance operation may include replacing a fuse, fastening motor wiring, replenishing lubricant, removing foreign matter from an impeller, or the like.

In some embodiments, the processor may determine the pressurization parameter and/or the maintenance parameter based on the water supply abnormality location and the water supply abnormality type in various manners. For example, the processor may determine the pressurization parameter and/or the maintenance parameter based on the water supply abnormality location and the water supply abnormality type by querying a first preset table. The first preset table may include mapping relationships between combinations of water supply abnormality locations and water supply abnormality types, and corresponding pressurization parameters and/or maintenance parameters. The first preset table may be constructed in advance manually based on historical data and/or historical experience.

In 240, a pressurization instruction including pressurization key nodes and preset water pressures is generated based on the pressurization parameter.

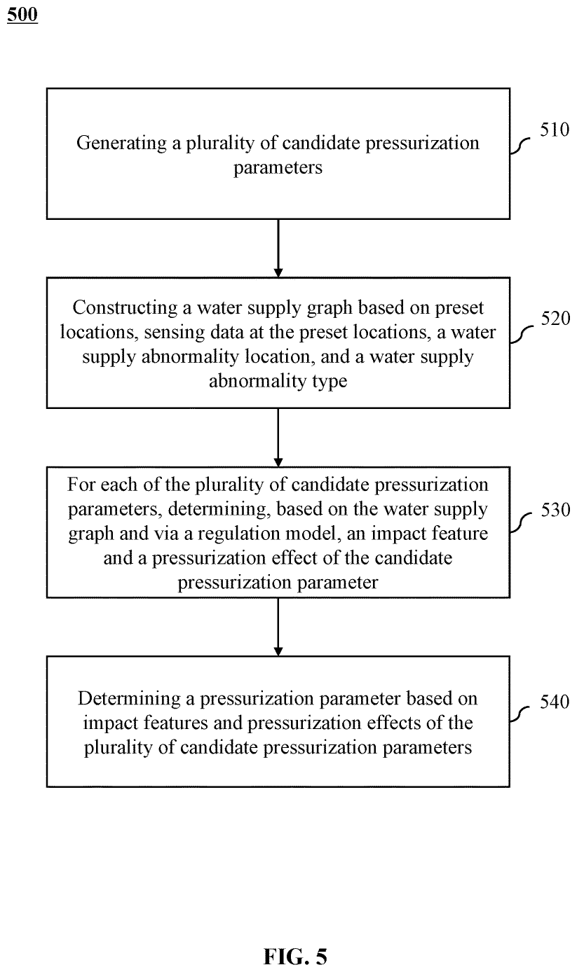

In some embodiments, the processor may generate a plurality of candidate pressurization parameters; construct a water supply graph based on the preset locations, the sensing data at the preset locations, the water supply abnormality location, and the water supply abnormality type; for each candidate pressurization parameter, determine, based on the water supply graph and via a regulation model, an impact feature and a pressurization effect of the candidate pressurization parameter; and determine the pressurization parameters based on impact features and pressurization effects of the plurality of candidate pressurization parameters. More details may be found in the related description of FIG. 5.

The pressurization instruction refers to an instruction for controlling a pressurization operation.

In some embodiments, the pressurization instruction is configured to control corresponding fire-fighting water pumps of the pressurization key nodes to adjust water pressures at the pressurization key nodes to respective preset water pressures.

In some embodiments, the processor may generate the pressurization instruction including the pressurization key nodes and the preset water pressures based on the pressurization parameter according to a preset instruction template.

In 250, a maintenance instruction including a maintenance location and a maintenance operation is generated based on the maintenance parameter.

The maintenance instruction refers to an instruction for controlling the maintenance operation.

In some embodiments, the maintenance instruction is configured to control a maintenance robot to move to the maintenance location and perform the maintenance operation on an abnormal fire-fighting water pump.

The maintenance robot refers to a robot configured to perform the maintenance operation. The maintenance robot may move to the maintenance location based on the maintenance instruction and perform the maintenance operation on the abnormal fire-fighting water pump to resolve a fault of the abnormal fire-fighting water pump.

In some embodiments, the processor may generate the maintenance instruction including the maintenance location and the maintenance operation based on the maintenance parameter according to a preset instruction template.

By determining the water supply abnormality location and the water supply abnormality type, and automatically generating, based thereon, a pressurization instruction including pressurization key nodes and preset water pressures or a maintenance instruction including a maintenance location and a maintenance operation, a full-process automated emergency response from abnormality monitoring, intelligent diagnosis, to precise handling is achieved, thereby improving timeliness, accuracy, and intelligence of fire-fighting water pressure supervision.

FIG. 3 is an exemplary schematic diagram of determining abnormal intervals corresponding to key nodes according to some embodiments of the present disclosure.

In some embodiments, the preset locations include key nodes and fire-fighting water pumps. As shown in FIG. 3, the processor may further determine a jurisdiction intensity 330 of a corresponding fire-fighting water pump with respect to a key node based on performance characteristics 310 of the corresponding fire-fighting water pump of the key node and a distance 320 between the corresponding fire-fighting water pump and the key node; and determine an abnormal interval 360 corresponding to the key node based on scenario features 340 of the key node, time-period features 350 of the key node, and a jurisdiction intensity 330 of the corresponding fire-fighting water pump with respect to the key node.

More details regarding the key nodes, the fire-fighting water pumps, the corresponding fire-fighting water pumps of the key nodes, the scenario features, and the time-period features may be found in the related descriptions of FIG. 2.

The performance characteristics refer to parameters that measure reliability of long-term operation of a fire-fighting water pump. In some embodiments, the performance characteristics may be represented by a ratio of a historical normal operating duration to a historical total operating duration of the fire-fighting water pump. Normal operation refers to operation in which operating data of the fire-fighting water pump is normal (e.g., not within corresponding abnormal intervals). The historical normal operating duration and the historical total operating duration may be obtained from historical records.

The distance between the corresponding fire-fighting water pump of a key node and the key node refers to a pipeline length between the corresponding fire-fighting water pump and the key node, which may be obtained based on an engineering structure diagram of a fire-fighting pipeline network.

The jurisdiction intensity of the corresponding fire-fighting water pump with respect to the key node is an indicator used to measure a water supply capability of the corresponding fire-fighting water pump to the key node. The jurisdiction intensity may be represented by a numerical value, where a larger value indicates a higher jurisdiction intensity and a stronger water supply capability of the corresponding fire-fighting water pump to the key node.

In some embodiments, the processor may determine the jurisdiction intensity of the corresponding fire-fighting water pump based on the performance characteristics of the corresponding fire-fighting water pump and the distance between the corresponding fire-fighting water pump and the key node in various manners. For example, the processor may normalize the performance characteristics of the corresponding fire-fighting water pump of the key node and the distance between the corresponding fire-fighting water pump and the key node, and perform a weighted summation, and determine a result of the weighted summation as the jurisdiction intensity of the corresponding fire-fighting water pump with respect to the key node. Weight coefficients used in the weighted summation may be set manually based on experience, wherein a weight coefficient corresponding to the distance is negative and a weight coefficient corresponding to the performance characteristics is positive. The normalization may include, but is not limited to, Min-Max normalization, Z-score normalization, or the like.

In some embodiments, the sensing data at the preset locations include operating data of the fire-fighting water pumps, and the jurisdiction intensity of a corresponding fire-fighting water pump with respect to a key node is related to the operating data of the corresponding fire-fighting water pump of the key node.

More details regarding the operating data of the fire-fighting water pumps may be found in the related description of FIG. 2. More details regarding the jurisdiction intensity may be found in the foregoing description.

In some embodiments, when a pump outlet pressure or a pump outlet flow rate in the operating data is lower, an operating condition of the fire-fighting water pump is poorer, and a long-distance water supply capability of the fire-fighting water pump is weaker. Accordingly, an absolute value of a weight coefficient corresponding to the distance between the corresponding fire-fighting water pump and the key node may be increased, such that the jurisdiction intensity of the corresponding fire-fighting water pump with respect to the key node is smaller. That is to say, as the pump outlet pressure or the pump outlet flow rate decreases, the jurisdiction intensity decreases.

By correlating the jurisdiction intensity of the corresponding fire-fighting water pump of the key node with the operating data thereof, even when the fire-fighting water pump has good long-term performance characteristics, the jurisdiction intensity can be dynamically reduced when an abnormal operating condition occurs, thereby reasonably adjusting abnormal intervals and avoiding underestimation of long-distance water supply risks due to reliance on a fire-fighting water pump in a poor operating condition.

In some embodiments, the processor may determine an abnormal interval corresponding to the key node by querying a scenario configuration repository based on the scenario features of the key node, the time-period features of the key node, and the jurisdiction intensity of the corresponding fire-fighting water pump with respect to the key node. The scenario configuration repository may include associations of scenario features and time-period features of key nodes with corresponding jurisdiction intensities of associated fire-fighting water pumps and abnormal intervals. Construction of the scenario configuration repository may be performed as described in step 210 and the related description, with the addition of the jurisdiction intensity when constructing the clustering vectors.

By determining the jurisdiction intensity of the fire-fighting water pump with respect to the key node based on performance characteristics of the corresponding fire-fighting water pump and the distance between the corresponding fire-fighting water pump and the key node, and determining the abnormal interval based on the jurisdiction intensity, the scenario features, and the time-period features, the determination of abnormal intervals takes into account not only external environmental factors but also device capability, thereby improving accuracy of abnormality determination.

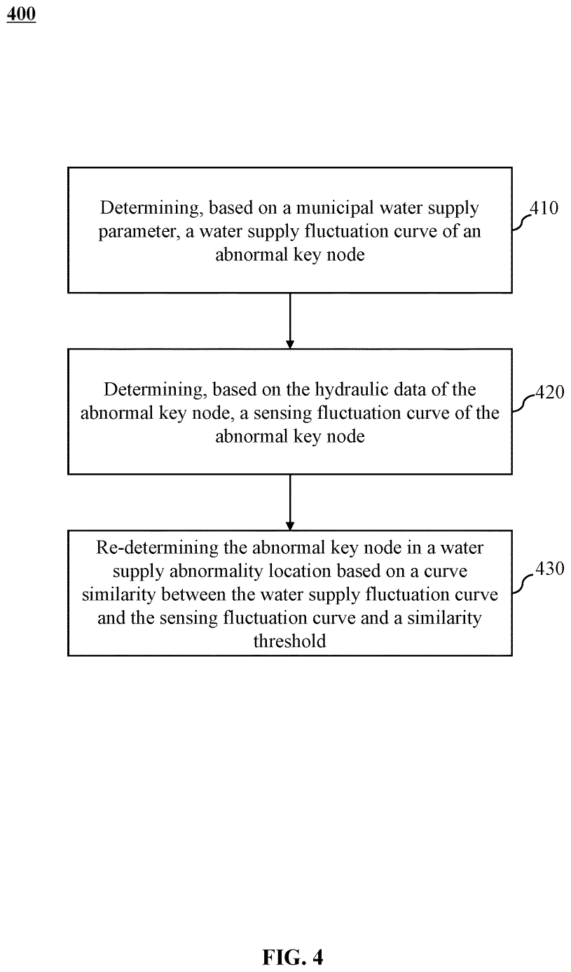

FIG. 4 is a flowchart of an exemplary process for re-determining abnormal key nodes according to some embodiments of the present disclosure. As shown in FIG. 4, a process 400 includes the following steps. In some embodiments, the process 400 may be performed by the emergency supervision management platform 130 of the system 100 for emergency supervision of fire-fighting water pressure in a smart city based on an IoT large model, for example, by a processor.

In some embodiments, sensing data at preset locations include hydraulic data of key nodes, and a water supply abnormality location includes an abnormal key node and an abnormal fire-fighting water pump.

More details regarding the hydraulic data, the abnormal key node, and the abnormal fire-fighting water pump may be found in the related description of FIG. 2.

In 410, a water supply fluctuation curve of an abnormal key node is determined based on a municipal water supply parameter.

The municipal water supply parameter refers to one or more parameters related to a current municipal water supply. For example, the municipal water supply parameter may include a most recently updated water supply pressure, a water supply flow rate, or the like, provided by a municipal authority. The municipal water supply parameter may be manually input or obtained by the processor via access to a platform of the municipal authority.

The water supply fluctuation curve refers to a variation curve of expected hydraulic data of a key node within a preset time period. The expected hydraulic data refers to hydraulic data under normal conditions (i.e., no water supply abnormality), including expected water pressure data and expected flow rate data.

The preset time period refers to a time interval between a most recent update time point of the municipal water supply parameter by the municipal authority and a current time. In some embodiments, the preset time period may be set manually based on experience. For example, the preset time period may be 3 minutes after the most recent update time point of the municipal water supply parameter.

In some embodiments, each key node corresponds to a water supply fluctuation curve. A horizontal axis of the water supply fluctuation curve represents time, and a vertical axis represents expected hydraulic data of the key node. The water supply fluctuation curve may be obtained by fitting a plurality of data points, wherein each data point represents expected water pressure data or expected flow rate data of the key node at a time point within the preset time period. The fitting algorithm may include, but is not limited to, a least squares method, polynomial regression, or the like.

In some embodiments, there may be a plurality of abnormal key nodes. For each abnormal key node, the processor may determine a corresponding water supply fluctuation curve based on the municipal water supply parameter in various manners.

For example, for a key node, the processor may construct a plurality of clustering vectors based on a plurality of historical municipal water supply parameters under normal water supply conditions, wherein each clustering vector is associated with a historical water supply fluctuation curve of the key node within a historical time period. The historical time period corresponds to a past time period having a same duration as the preset time period, for example, 3 minutes after a corresponding update time point of the historical municipal water supply parameters. The historical water supply fluctuation curve may be obtained by fitting a plurality of historical data points, wherein each historical data point represents actual water pressure data or actual flow rate data of the key node at a historical time point within the historical time period.

For an abnormal key node, the processor may construct a plurality of clustering vectors in the above manner, and construct a target vector based on a current municipal water supply parameter. The processor may perform clustering analysis on the plurality of clustering vectors and the target vector to generate a plurality of clusters, determine a cluster to which the target vector belongs as a target cluster, and determine an average curve of historical water supply fluctuation curves associated with all clustering vectors in the target cluster as the water supply fluctuation curve of the abnormal key node.

The average curve may be obtained by aligning a plurality of historical water supply fluctuation curves in time and calculating pointwise average values. The clustering manner may include, but is not limited to, k-means clustering, mean-shift clustering, or the like.

In 420, a sensing fluctuation curve of the abnormal key node is determined based on the hydraulic data of the abnormal key node.

More details regarding the hydraulic data of the abnormal key node may be found in the related description of FIG. 2.

The sensing fluctuation curve refers to a variation curve of actual hydraulic data of a key node within the preset time period.

In some embodiments, each key node corresponds to a sensing fluctuation curve. A horizontal axis of the sensing fluctuation curve represents time, and a vertical axis represents actual hydraulic data of the key node.

In some embodiments, the processor may determine the sensing fluctuation curve of the abnormal key node based on the hydraulic data of the abnormal key node in various manners. For example, the sensing fluctuation curve of the abnormal key node may be obtained by fitting a plurality of data points, wherein each data point represents water pressure data or flow rate data of the abnormal key node at a time point within the preset time period.

In 430, the abnormal key node in the water supply abnormality location is re-determined based on a curve similarity between the water supply fluctuation curve and the sensing fluctuation curve and a similarity threshold.

The curve similarity refers to a degree of similarity between the water supply fluctuation curve and the sensing fluctuation curve.

In some embodiments, the curve similarity may be represented by a Pearson correlation coefficient or other similarity measures.

The similarity threshold refers to a similarity value used to determine whether a key node has a water supply abnormality. In some embodiments, the similarity threshold may be preset manually based on experience.

In some embodiments, the similarity threshold may be further related to an abnormal interval corresponding to the abnormal key node.

In some embodiments, the processor may determine the similarity threshold based on a degree of difference between an abnormal interval determined by querying the scenario configuration repository and a standard abnormal interval, wherein the degree of difference is represented by a difference in interval widths between the abnormal interval and the standard abnormal interval. The interval width is represented by a difference between an upper bound and a lower bound of the interval.

When a width of the abnormal interval is greater than a width of a standard abnormal interval, it indicates that a scenario or a time period in which the current key node is located imposes a higher requirement on stability of water supply. Accordingly, the similarity threshold may be set to a higher value, and the larger a difference in interval widths, the higher the similarity threshold may be set. Conversely, when the width of the abnormal interval is smaller than the width of the standard abnormal interval, it indicates that the scenario or the time period in which the current key node is located imposes a lower requirement on stability of water supply, and the similarity threshold may be correspondingly reduced. More details regarding the abnormal intervals determined from the scenario configuration repository and the standard abnormal intervals may be found in the related descriptions of FIG. 2 and FIG. 3.

By correlating the similarity threshold with the abnormal interval corresponding to the abnormal key node, a similarity determination criterion is dynamically adjusted according to supervision requirements of a scenario in which the key node is located, thereby improving adaptability and accuracy of water supply abnormality identification and avoiding missed detections caused by overly permissive criteria in sensitive scenarios.

In some embodiments, when the curve similarity between the water supply fluctuation curve and the sensing fluctuation curve is greater than or equal to the similarity threshold, the abnormal key node is determined to be in a normal fluctuation state, indicating that the abnormal key node is a falsely identified pseudo-abnormal key node. When the curve similarity is less than the similarity threshold, the abnormal key node is determined to have an actual water supply abnormality, indicating that the abnormal key node is a true abnormal key node that is not falsely identified.

The normal fluctuation state refers to a condition in which a fluctuation of actual hydraulic data of the abnormal key node is substantially consistent with a fluctuation of expected hydraulic data, indicating that the fluctuation of the hydraulic data of the abnormal key node is caused by normal physical behavior rather than by a water supply abnormality.

By performing similarity analysis between the water supply fluctuation curve derived from the municipal water supply parameter and the sensing fluctuation curve, a secondary verification is performed on a preliminarily identified abnormal key node, thereby effectively distinguishing normal data fluctuations caused by external municipal water supply variations from actual water supply abnormalities. As a result, the water supply abnormality location can be accurately corrected, improving precision of abnormality identification and reducing false positives and missed detections.

FIG. 5 is a flowchart of an exemplary process for determining a pressurization parameter according to some embodiments of the present disclosure. As shown in FIG. 5, a process 500 includes the following steps. In some embodiments, the process 500 may be performed by the emergency supervision management platform 130 of the system 100 for emergency supervision of fire-fighting water pressure in a smart city based on an IoT large model, for example, by a processor.

In 510, a plurality of candidate pressurization parameters are generated.

The candidate pressurization parameters refer to candidate parameters for adjusting water pressure in a fire-fighting pipeline network. For example, each candidate pressurization parameter may include one or more candidate pressurization key nodes and corresponding candidate preset water pressures.

In some embodiments, the processor may generate the plurality of candidate pressurization parameters in various manners. For example, the processor may randomly combine a plurality of candidate pressurization key nodes with a plurality of candidate preset water pressures to generate a plurality of parameter combinations, each including candidate pressurization key nodes and corresponding candidate preset water pressures, wherein each parameter combination constitutes a candidate pressurization parameter. The candidate pressurization key nodes may include historical pressurization key nodes, and the candidate preset water pressures may be obtained by performing incremental adjustments to historical preset water pressures corresponding to the candidate pressurization key nodes.

In 520, a water supply graph is constructed based on preset locations, sensing data at the preset locations, a water supply abnormality location, and a water supply abnormality type.

The water supply graph refers to a graph structure configured to represent topological connection relationships and operating states of the preset locations. The water supply graph may include at least two nodes and at least one edge.

Nodes of the water supply graph correspond to preset locations in the fire-fighting pipeline network, including normal nodes and abnormal nodes. The normal nodes include normal key nodes and normal fire-fighting water pumps. The abnormal nodes correspond to water supply abnormality locations and include abnormal key nodes and abnormal fire-fighting water pumps.

Node features of the normal key nodes include hydraulic data of the normal key nodes. Node features of the normal fire-fighting water pumps include operating parameters and operating data of the normal fire-fighting water pumps. The operating parameters refer to inherent design parameters of the fire-fighting water pumps. For example, the operating parameters may include a rated power, a rated flow rate, a rated head, a rated rotational speed, a rated motor voltage, a pump efficiency, or the like. Node features of the abnormal key nodes may include sensing data of the abnormal key nodes and corresponding water supply abnormality types. Node features of the abnormal fire-fighting water pumps include operating data of the abnormal fire-fighting water pumps and corresponding water supply abnormality types. More details regarding the water supply abnormality type may be found In 220 and the related description.

Edges of the water supply graph are directed edges representing water supply pipelines between two nodes. A direction of each edge is from an upstream node to a downstream node. Edge features may include dimensional parameters of the water supply pipelines, such as a pipeline length, an inner diameter, an elevation difference, a pipe wall thickness, or the like.

In some embodiments, the processor may generate the water supply graph based on an engineering structure diagram of the fire-fighting pipeline network by establishing directed edges between nodes according to pipeline connection relationships, with directions from upstream to downstream.

In 530, for each candidate pressurization parameter, an impact feature and a pressurization effect of the candidate pressurization parameter are determined based on the water supply graph via a regulation model.

The regulation model may be a machine learning model, for example, a neural network (Neural Network, NN), or any other customized model structure, or a combination thereof.

In some embodiments, inputs to the regulation model may include the water supply graph and a candidate pressurization parameter, and outputs of the regulation model may include the impact feature and the pressurization effect of the candidate pressurization parameter.

The impact feature refers to an influence of pressurization at abnormal nodes on normal nodes. The impact feature of the candidate pressurization parameter may be represented by an average value of water pressure fluctuation amplitudes of all normal nodes when pressurization is applied to the abnormal nodes according to the candidate pressurization parameter. The water pressure fluctuation amplitude may be represented by an absolute value of a change in water pressure data before and after pressurization.

The pressurization effect refers to an effect of pressurization applied to abnormal nodes. The pressurization effect of the candidate pressurization parameter may be represented by a time duration from initiation of pressurization to restoration of water pressure at the abnormal nodes to preset water pressures.

In some embodiments, the regulation model may be obtained through training based on a plurality of first training samples with first labels. The processor may input the plurality of first training samples with first labels into an initial regulation model, construct a loss function based on the first labels and output results of the initial regulation model, and iteratively update parameters of the initial regulation model based on the loss function using techniques such as gradient descent. When the loss function satisfies a preset condition, a trained regulation model is obtained. The preset condition may include convergence of the loss function, a count of iterations reaching a threshold, or the like.

The first training samples and the first labels may be obtained based on historical data. Each first training sample may include a historical water supply graph and a historical pressurization parameter. A first label corresponding to each first training sample may include an actual impact feature corresponding to historical normal nodes and an actual pressurization effect corresponding to historical abnormal nodes after pressurization is performed according to the historical pressurization parameter. The actual impact feature may be represented by an average value of actual water pressure fluctuation amplitudes of all historical normal nodes when pressurization is applied to historical abnormal nodes according to the historical pressurization parameter. The actual pressurization effect may be represented by a time duration from initiation of pressurization to restoration of water pressure at the historical abnormal nodes to historical preset water pressures.

In some embodiments, in the water supply graph, edge features of edges between normal nodes and abnormal nodes of a same type include a degree of influence of an abnormal node on a normal node.

The degree of influence refers to a magnitude of disturbance caused by data fluctuations of an abnormal node to a normal node of the same type, including an influence of fluctuations of hydraulic data of abnormal key nodes on hydraulic data of normal key nodes and an influence of fluctuations of operating data of abnormal fire-fighting water pumps on operating data of normal fire-fighting water pumps.

In some embodiments, the degree of influence may be obtained based on historical data. During a historical time period, when hydraulic data of an abnormal key node changes, a fluctuation amplitude of the hydraulic data of the abnormal key node within the historical time period may be determined, and a fluctuation amplitude of hydraulic data of a normal key node of the same type connected thereto via an edge within the historical time period may be determined. A ratio between the fluctuation amplitude corresponding to the abnormal key node and the fluctuation amplitude corresponding to the normal key node may then be calculated. Based on historical data across a plurality of historical time periods, a plurality of such ratios may be obtained, and an average value of the plurality of ratios may be determined as the degree of influence of the abnormal key node on the normal key node of the same type. The historical time periods may be selected manually, and the fluctuation amplitude may be represented by an absolute value of a change in data.

In some embodiments, the processor may reconstruct the water supply graph by incorporating the degree of influence of abnormal nodes on normal nodes into edge features of the water supply graph. The construction process of the water supply graph may refer to step 520 and the related description. The processor may input the reconstructed water supply graph into the regulation model to re-determine the impact feature and the pressurization effect of the candidate pressurization parameter. Correspondingly, historical water supply graphs in the first training samples used for training the regulation model may also include the edge feature representing the degree of influence of abnormal nodes on normal nodes.

By introducing the degree of influence of abnormal nodes on normal nodes into the edge features of the water supply graph, the regulation model is enabled to more accurately characterize propagation relationships of hydraulic disturbances within the fire-fighting pipeline network, thereby improving prediction accuracy of potential cascading fluctuations caused by pressurization operations and facilitating selection of a regulation scheme that minimizes disturbances to normal nodes.

In 540, the pressurization parameter is determined based on impact features and pressurization effects of the plurality of candidate pressurization parameters.

In some embodiments, for each candidate pressurization parameter, the processor may normalize the corresponding impact feature and pressurization effect and perform a weighted summation, and determine the weighted sum as a regulation effect corresponding to the candidate pressurization parameter. The processor may determine the candidate pressurization parameter having a minimum regulation effect as the pressurization parameter.

Weight coefficients for the weighted summation may be preset manually based on experience.

By constructing the water supply graph and evaluating and selecting the pressurization parameter from a plurality of candidate pressurization parameters based on the regulation model, precise and efficient regulation of water supply abnormalities can be achieved. While rapidly restoring water pressure at the water supply abnormality location, disturbances to normal nodes are effectively suppressed, thereby improving operational stability and intelligence of the fire-fighting pipeline network.

In some embodiments of the present disclosure, a non-transitory computer-readable storage medium is further provided. The storage medium stores computer instructions, and when the computer instructions stored in the storage medium are read by a computer, the computer performs the method for emergency supervision of fire-fighting water pressure in a smart city based on an Internet-of-Things (IoT) large model according to any one of the foregoing embodiments.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

Meanwhile, the present disclosure uses specific terms to describe the embodiments herein. Terms such as “one embodiment,” “an embodiment,” and/or “some embodiments” mean that a certain feature, structure, or characteristic related to at least one embodiment of the present disclosure. Therefore, it is emphasized and noted that the terms “an embodiment,” “one embodiment,” or “an alternative embodiment” mentioned two or more times at different locations in the present disclosure do not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers or letters, or the use of other names in the present disclosure is not intended to limit the order of the processes and methods described herein. Although the foregoing disclosure discusses some currently considered useful inventive embodiments through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the system components described above may be implemented via hardware devices, they may also be realized solely through software solutions, such as installing the described system on existing servers or mobile devices.

Similarly, it should be noted that to simplify the presentation of the present disclosure and thereby aid in understanding one or more inventive embodiments, in the descriptions of the embodiments of the present disclosure above, various features may sometimes be grouped into a single embodiment, figure, or description thereof. However, this disclosure manner does not imply that the subject matter of the present disclosure requires more features than those mentioned in the claims. In fact, the features of an embodiment are fewer than all the features of a single embodiment disclosed above.

In some embodiments, numbers describing quantities or attributes are used. It should be understood that such numbers used in the description of the embodiments may, in some examples, be modified by the terms “approximately,” “about,” or “substantially.” Unless otherwise specified, “approximately,” “about,” or “substantially” indicates that the stated number allows for a variation of ±20%. Accordingly, in some embodiments, the numerical parameters used in the specification and claims are approximations, which may vary depending on the characteristics required by individual embodiments. In some embodiments, numerical parameters should consider the specified number of significant digits and adopt the method of general digit retention. Although the numerical ranges and parameters used to confirm their breadth in some embodiments of the present disclosure are approximations, in specific embodiments, such numerical values are set as accurately as possible within the feasible range.

For each patent, patent application, patent application publication, and other material, such as articles, books, specifications, publications, documents, etc., cited in the present disclosure, the entire content thereof is hereby incorporated by reference into the present disclosure. Excluded are application history documents that are inconsistent or conflict with the content of the present disclosure, and documents that limit the broadest scope of the claims of the present disclosure (whether currently or subsequently appended to the present disclosure). It should be noted that if the description, definition, and/or use of terms in the supplementary materials of the present disclosure are inconsistent or conflict with those in the present disclosure, the description, definition, and/or use of terms in the present disclosure shall prevail.

Finally, it should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. A system for emergency supervision of fire-fighting water pressure in a smart city based on an Internet of Things (IoT) large model, wherein the system includes an emergency supervision management platform,
the emergency supervision management platform is configured to:
determine a water supply abnormality location based on sensing data at preset locations in a fire-fighting pipeline network;
determine a water supply abnormality type at the water supply abnormality location based on sensing data at the water supply abnormality location;
determine a pressurization parameter and/or a maintenance parameter based on the water supply abnormality location and the water supply abnormality type;
generate, based on the pressurization parameter, a pressurization instruction including pressurization key nodes and preset water pressures, the pressurization instruction being configured to control corresponding fire-fighting water pumps at the pressurization key nodes to adjust water pressures at the pressurization key nodes to the preset water pressures; and
generate, based on the maintenance parameter, a maintenance instruction including a maintenance location and a maintenance operation, the maintenance instruction being configured to control a maintenance robot to move to the maintenance location and perform the maintenance operation on an abnormal fire-fighting water pump.

2. The system of claim 1, wherein the emergency supervision management platform is further configured to:
determine, based on scenario features and time-period features of the preset locations, abnormal intervals corresponding to the preset locations.

3. The system of claim 2, wherein the preset locations include key nodes and fire-fighting water pumps, and the emergency supervision management platform is further configured to:
determine, based on performance characteristics of a corresponding fire-fighting water pump of a key node and a distance between the corresponding fire-fighting water pump and the key node, a jurisdiction intensity of the corresponding fire-fighting water pump with respect to the key node; and
determine, based on the scenario features of the key node, the time-period features of the key node, and the jurisdiction intensity of the corresponding fire-fighting water pump with respect to the key node, an abnormal interval corresponding to the key node.

4. The system of claim 3, wherein the sensing data at the preset locations includes operating data of the fire-fighting water pumps, and the jurisdiction intensity of the corresponding fire-fighting water pump with respect to the key node is related to the operating data of the corresponding fire-fighting water pump of the key node.

5. The system of claim 1, wherein the sensing data at the preset locations includes hydraulic data of key nodes, the water supply abnormality location includes an abnormal key node and the abnormal fire-fighting water pump, and the emergency supervision management platform is further configured to:
determine, based on a municipal water supply parameter, a water supply fluctuation curve of the abnormal key node;
determine, based on the hydraulic data of the abnormal key node, a sensing fluctuation curve of the abnormal key node; and
re-determine the abnormal key node in the water supply abnormality location based on a curve similarity between the water supply fluctuation curve and the sensing fluctuation curve and a similarity threshold.

6. The system of claim 5, wherein the similarity threshold is related to an abnormal interval corresponding to the abnormal key node.

7. The system of claim 1, wherein the emergency supervision management platform is further configured to:
generate a plurality of candidate pressurization parameters;
construct a water supply graph based on the preset locations, the sensing data at the preset locations, the water supply abnormality location, and the water supply abnormality type;
for each of the plurality of candidate pressurization parameters, determine, based on the water supply graph and via a regulation model, an impact feature and a pressurization effect of the candidate pressurization parameter, wherein the regulation model is a machine learning model; and
determine the pressurization parameter based on impact features and pressurization effects of the plurality of candidate pressurization parameters.

8. The system of claim 7, wherein, in the water supply graph, edge features of edges between normal nodes and abnormal nodes of a same type include a degree of influence of the abnormal nodes on the normal nodes.

9. A method for emergency supervision of fire-fighting water pressure in a smart city, implemented by an emergency supervision management platform of a system for emergency supervision of fire-fighting water pressure in the smart city based on an IoT large model, the method comprising:
determining a water supply abnormality location based on sensing data at preset locations in a fire-fighting pipeline network;
determining a water supply abnormality type at the water supply abnormality location based on sensing data at the water supply abnormality location;
determining a pressurization parameter and/or a maintenance parameter based on the water supply abnormality location and the water supply abnormality type;
generating, based on the pressurization parameter, a pressurization instruction including pressurization key nodes and preset water pressures, the pressurization instruction being configured to control corresponding fire-fighting water pumps at the pressurization key nodes to adjust water pressures at the pressurization key nodes to the preset water pressures; and
generating, based on the maintenance parameter, a maintenance instruction including a maintenance location and a maintenance operation, the maintenance instruction being configured to control a maintenance robot to move to the maintenance location and perform the maintenance operation on an abnormal fire-fighting water pump.

10. The method of claim 9, further comprising:
determining, based on scenario features and time-period features of the preset locations, abnormal intervals corresponding to the preset locations.

11. The method of claim 10, wherein the preset locations include key nodes and fire-fighting water pumps, and the determining, based on scenario features and time-period features of the preset locations, abnormal intervals corresponding to the preset locations includes:
determining, based on performance characteristics of a corresponding fire-fighting water pump of a key node and a distance between the corresponding fire-fighting water pump and the key node, a jurisdiction intensity of the corresponding fire-fighting water pump with respect to the key node; and
determining, based on the scenario features of the key node, the time-period features of the key node, and the jurisdiction intensity of the corresponding fire-fighting water pump with respect to the key node, an abnormal interval corresponding to the key node.

12. The method of claim 11, wherein the sensing data at the preset locations includes operating data of the fire-fighting water pumps, and the jurisdiction intensity of the corresponding fire-fighting water pump with respect to the key node is related to the operating data of the corresponding fire-fighting water pump of the key node.

13. The method of claim 9, wherein the sensing data at the preset locations includes hydraulic data of key nodes, the water supply abnormality location includes an abnormal key node and the abnormal fire-fighting water pump, and the method further comprises:
determining, based on a municipal water supply parameter, a water supply fluctuation curve of the abnormal key node;
determining, based on the hydraulic data of the abnormal key node, a sensing fluctuation curve of the abnormal key node; and
re-determining the abnormal key node in the water supply abnormality location based on a curve similarity between the water supply fluctuation curve and the sensing fluctuation curve and a similarity threshold.

14. The method of claim 13, wherein the similarity threshold is related to an abnormal interval corresponding to the abnormal key node.

15. The method of claim 9, wherein the determining a pressurization parameter maintenance parameter based on the water supply abnormality location and the water supply abnormality type includes:
generating a plurality of candidate pressurization parameters;
constructing a water supply graph based on the preset locations, the sensing data at the preset locations, the water supply abnormality location, and the water supply abnormality type;
for each of the plurality of candidate pressurization parameters, determining, based on the water supply graph and via a regulation model, an impact feature and a pressurization effect of the candidate pressurization parameter, wherein the regulation model is a machine learning model; and
determining the pressurization parameter based on impact features and pressurization effects of the plurality of candidate pressurization parameters.

16. The method of claim 15, wherein, in the water supply graph, edge features of edges between normal nodes and abnormal nodes of a same type include a degree of influence of the abnormal nodes on the normal nodes.

17. A non-transitory computer-readable storage medium storing computer instructions, wherein, when the computer instructions are read by a computer, the computer is caused to perform a method for emergency supervision of fire-fighting water pressure in a smart city, the method comprising:
determining a water supply abnormality location based on sensing data at preset locations in a fire-fighting pipeline network;
determining a water supply abnormality type at the water supply abnormality location based on sensing data at the water supply abnormality location;
determining a pressurization parameter and/or a maintenance parameter based on the water supply abnormality location and the water supply abnormality type;
generating, based on the pressurization parameter, a pressurization instruction including pressurization key nodes and preset water pressures, the pressurization instruction being configured to control corresponding fire-fighting water pumps at the pressurization key nodes to adjust water pressures at the pressurization key nodes to the preset water pressures; and
generating, based on the maintenance parameter, a maintenance instruction including a maintenance location and a maintenance operation, the maintenance instruction being configured to control a maintenance robot to move to the maintenance location and perform the maintenance operation on an abnormal fire-fighting water pump.
